(19) United States
(12) Patent Application Publication
(10) Pub. No.: US 2025/0220459 A1
(43) Pub. Date: Jul. 3, 2025

(54) METHOD FOR TRANSMITTING MEASUREMENT CONFIGURATION INFORMATION, APPARATUS AND READABLE STORAGE MEDIUM

(71) Applicant: BEIJING XIAOMI MOBILE SOFTWARE CO., LTD., Beijing (CN)

(72) Inventor: Xuhua TAO, Beijing (CN)

(73) Assignee: BEIJING XIAOMI MOBILE SOFTWARE CO., LTD., Beijing (CN)

(21) Appl. No.: 18/851,382

(22) PCT Filed: Mar. 30, 2022
(86) PCT No.: PCT/CN2022/084146

§ 371 Date: Sep. 26, 2024

(51) Int. Cl. H04W 24/02; H04W 8/22; H04W 24/10; H04W 76/15

(52) U.S. Cl. CPC H04W 24/02; H04W 8/22; H04W 24/10; H04W 76/15

(57) ABSTRACT

A method for transmitting measurement configuration information includes sending measurement capability to a network device, and receiving the measurement configuration information, where the measurement capability is used for indicating whether the UE supports performing, without using a measurement gap, an inter-system measurement on a system to be measured, the measurement configuration information includes indication information, and the indication information is used for indicating whether the UE is allowed to perform the inter-system measurement on the system without using the measurement gap.

### CROSS REFERENCE TO RELATED APPLICATION

The present application is a U.S. National Stage of International Application No. PCT/CN2022/084146, filed on Mar. 30, 2022, which is incorporated by reference herein in its entireties for all purposes.

### TECHNICAL FIELD

The present disclosure relates to the field of wireless communication technologies, and in particular to a method and apparatus for transmitting measurement configuration information, and a readable storage medium.

### BACKGROUND

In a wireless communication system, for example, in a new radio (NR) wireless communication system, a user equipment (UE) is required to perform an inter-system measurement by using a measurement gap configured by a network device. When using the measurement gap, in a duration corresponding to the measurement gap, the UE suspends communication with a serving cell, adjusts a radio frequency (RF) receiver to a frequency point of a target cell of the inter-system, and performs the inter-frequency measurement of the inter-system. After the duration corresponding to the measurement gap is over, the UE resumes communication with the serving cell.

### SUMMARY

The present disclosure provides a method and apparatus for transmitting measurement configuration information, and a readable storage medium.

In a first aspect, there is provided a method for transmitting measurement configuration information, which is performed by a UE, and the method includes:
sending measurement capability to a network device, where the measurement capability is used for indicating whether the UE supports performing, without using a measurement gap, an inter-system measurement on a system to be measured; and
receiving the measurement configuration information, where the measurement configuration information includes indication information, and the indication information is used for indicating whether the UE is allowed to perform, without using the measurement gap, the inter-system measurement on the system to be measured.

In a second aspect, there is provided a method for transmitting measurement configuration information, which is performed by a network device, and the method includes: receiving measurement capability sent by a UE, where the measurement capability is used for indicating whether the UE supports performing, without using a measurement gap, an inter-system measurement on a system to be measured;
determining indication information based on the measurement capability, where the indication information is used for indicating whether the UE is allowed to perform, without using the measurement gap, the inter-system measurement on the system to be measured; and
sending the measurement configuration information to the UE, where the measurement configuration information includes the indication information.

In a third aspect, there is provided a communication device that includes a processor and a memory. The memory is configured to store a computer program; and the processor is configured to execute the computer program, thereby implementing the first aspect or any one of the possible designs of the first aspect.

In a fourth aspect, there is provided a communication device that includes a processor and a memory. The memory is configured to store a computer program; and the processor is configured to execute the computer program, thereby implementing the second aspect or any one of the possible designs of the second aspect.

In a fifth aspect, there is provided a computer-readable storage medium. The computer-readable storage medium stores an instruction (or referred to as a computer program, or a program) that, when invoked and executed on a computer, causes the computer to perform the first aspect or any one of the possible designs of the first aspect.

In a sixth aspect, there is provided a computer-readable storage medium. The computer-readable storage medium stores an instruction (or referred to as a computer program, or a program) that, when invoked and executed on a computer, causes the computer to perform the second aspect or any one of the possible designs of the second aspect.

It should be understood that the above general description and the subsequent detailed description are exemplary and explanatory only, and do not limit the present disclosure.

### BRIEF DESCRIPTION OF THE DRAWINGS

The accompanying drawings illustrated herein are used for providing a further understanding of the embodiments of the present disclosure and form part of the present application, and the schematic embodiments of the embodiments of the present disclosure and their illustrations are used for explaining the embodiments of the present disclosure and do not constitute an undue limitation on the embodiments of the present disclosure.

The accompanying drawings herein are incorporated into the specification and form part of the specification, illustrating embodiments in accordance with the embodiments of the present disclosure and used together with the specification to explain principles of the embodiments of the present disclosure.

FIG. 1 is a schematic diagram of an architecture of a wireless communication system provided by an embodiment of the present disclosure.

FIG. 2 is a schematic diagram of a method for transmitting measurement configuration information illustrated according to an exemplary embodiment.

FIG. 3 is a flowchart of a method for receiving measurement configuration information illustrated according to an exemplary embodiment.

FIG. 4 is a flowchart of a method for receiving measurement configuration information illustrated according to an exemplary embodiment.

FIG. 5 is a flowchart of a method for sending measurement configuration information illustrated according to an exemplary embodiment.

FIG. 6 is a flowchart of a method for sending measurement configuration information illustrated according to an exemplary embodiment.

FIG. 7 is a structural diagram of an apparatus for receiving measurement configuration information illustrated according to an exemplary embodiment.

FIG. 8 is a structural diagram of an apparatus for receiving measurement configuration information illustrated according to an exemplary embodiment.

FIG. 9 is a structural diagram of an apparatus for sending measurement configuration information illustrated according to an exemplary embodiment.

FIG. 10 is a structural diagram of an apparatus for sending measurement configuration information illustrated according to an exemplary embodiment.

### DETAILED DESCRIPTION

The embodiments of the present disclosure are further described in connection with the accompanying drawings and the DETAILED DESCRIPTION.

The exemplary embodiments are described in detail here, examples of which are indicated in the accompanying drawings. When the following description involves the accompanying drawings, the same numerals in different accompanying drawings indicate the same or similar elements unless otherwise indicated. The embodiments described in the following exemplary embodiments do not represent all embodiments consistent with the embodiments of the present disclosure. On the contrary, they are only examples of devices and methods consistent with some aspects of the present disclosure as detailed in the appended claims.

The terms used in the embodiments of the present disclosure are used solely for the purpose of describing particular embodiments, and are not intended to limit the embodiments of the present disclosure. The singular forms of “a” and “the” used in the embodiments of the present disclosure and the appended claims are also intended to include the majority form, unless the context clearly indicates other meanings. It should also be understood that the term “and/or” as used in this article refers to and includes any or all possible combinations of one or more of the associated listed items.

It should be understood that although the terms first, second, third, etc. may be used in the embodiments of the present disclosure to describe various types of information, such information should not be limited to these terms. These terms are only used to distinguish the same type of information from one another. For example, without departing from the scope of the embodiments of the present disclosure, the first information may also be referred to as the second information, and similarly, the second information may also be referred to as the first information. Depending on the context, the phrase “if” and “in case” as used herein may be interpreted as “at the time of . . . ”, “when . . . ”, or “in response to determining”.

The embodiments of the present disclosure are described in detail below, and examples of the embodiments are shown in the accompanying drawings, where the same or similar symbols throughout indicate the same or similar elements. The embodiments described below with reference to the accompanying drawings are exemplary and intended to be used for explaining the present disclosure, and should not be construed as the limitation on the present disclosure.

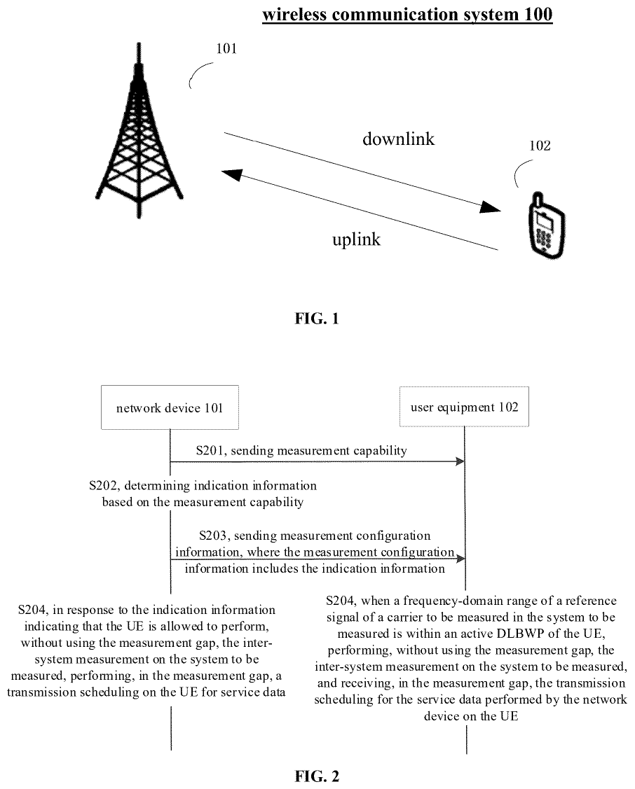

As shown in FIG. 1, a method for transmitting measurement configuration information provided by the embodiments of the present disclosure may be applied to a wireless communication system 100. The wireless communication system 100 may include, but is not limited to, a network device 101 and a UE 102. The UE 102 is configured to support carrier aggregation, and the UE 102 may be connected to a plurality of carrier units of the network device 101, where the plurality of carrier units include a primary carrier unit and one or multiple secondary carrier units.

It should be understood that the wireless communication system 100 may be applicable to both low frequency and high frequency scenarios. Application scenarios of the wireless communication system 100 include, but are not limited to, a long term evolution (LTE) system, an LTE frequency division duplex (FDD) system, an LTE time division duplex (TDD) system, a worldwide interoperability for microwave access (WiMAX) communication system, a cloud radio access network (CRAN) system, a future 5th-generation (5G) system, a new radio (NR) communication system, or a future evolution public land mobile network (PLMN) system, etc.

The UE 102 shown above may be a user equipment, a terminal, an access terminal, a terminal unit, a terminal station, a mobile station (MS), a remote station, a remote terminal, a mobile terminal, a wireless communication device, a terminal agent, or a user device, etc. The UE 102 may have a wireless transceiving function, and be capable of communicating (e.g., wirelessly communicating) with one or more network devices 101 of one or more communication systems, and accepting network service provided by the network device 101, where the network device 101 herein includes, but is not limited to, the base station illustrated in the drawing.

In some embodiments, the UE 102 may be a cellular phone, a cordless phone, a session initiation protocol (SIP) phone, a wireless local loop (WLL) station, a personal digital assistant (PDA) device, a handheld device with a wireless communication function, a computing device or other processing device connected to a wireless modem, an in-vehicle device, a wearable device, a user device in a future 5G network, or a user device in a future evolution PLMN network, etc.

The network device 101 may be an access network device (or referred to as an access network site). In some embodiments, the access network device refers to a device providing a network access function, such as a radio access network (RAN) base station. The network device may specifically include a base station (BS) device, or include the base station device and a radio resource management device configured to control the base station device. The network device may further include a relay station (a relay device), an access point, and a base station in the future 5G network, a base station in the future evolution PLMN network, or an NR base station, etc. The network device may be a wearable device or an in-vehicle device. The network device may also be a communication chip with a communication module.

For example, the network device 101 includes, but is not limited to, a next-generation base station (gnodeB, gNB) in 5G, an evolved node B (eNB) in the LTE system, a radio network controller (RNC), a node B (NB) in a wideband code division multiple access (WCDMA) system, a radio controller under the CRAN system, a base station controller (BSC), a base transceiver station (BTS) in a global system for mobile communication (GSM) system or a code division multiple access (CDMA) system, a home base station (for example, a home evolved nodeB, or a home node B (HNB)), a baseband unit (BBU), a transmitting and receiving point (TRP), a transmitting point (TP), or a mobile switching center, etc.

The inter-system measurement is an inter-RATE-UTRAN measurement or an inter-RATNR measurement. The inter-RATE-UTRAN measurement refers to a measurement for a long term evolution (LTE) carrier performed by a UE in an NR system, and the inter-RATNR measurement refers to a measurement for an NR carrier performed by a UE in an LTE system in a multi-radio dual connectivity (MR-DC) scenario (EN-DC or NE-DC). However, in some cases, the UE can perform the inter-system measurement without using the measurement gap. If the network device still configures the measurement gap in these cases, it will result in a loss of service processing performance of the UE. When a frequency-domain range of a reference signal of a carrier to be measured in an inter-system to be measured is entirely within a downlink active bandwidth part (BWP) of the UE, the UE can perform and complete the inter-system measurement without using the measurement gap.

Thus, the embodiments of the present disclosure provide a method for transmitting measurement configuration information. FIG. 2 is a flowchart of a method for transmitting measurement configuration information illustrated according to an exemplary embodiment. As shown in FIG. 2, the method includes steps S201 to S204, and the specifics are as follows.

At step S201, a UE sends measurement capability to a network device.

The measurement capability is used for indicating whether the UE supports performing, without using a measurement gap, an inter-system measurement on a system to be measured.

After receiving the measurement capability sent by the UE, the network device is informed about whether the UE supports performing, without using the measurement gap, the inter-system measurement on the system to be measured.

In some possible embodiments, the UE sends the measurement capability to the network device by sending to the network device IEMeasAndMobParameters signaling or IEMeasAndMobParametersMRDC signaling including the measurement capability.

At step S202, the network device determines indication information based on the measurement capability.

The indication information is used for indicating whether the UE is allowed to perform, without using the measurement gap, the inter-system measurement on the system to be measured.

In some possible embodiments, the indication information determined by the network device based on the measurement capability includes at least one of the following: when the measurement capability indicates that the UE supports performing, without using the measurement gap, the inter-system measurement on the system to be measured, the indication information determined by the network device indicating that the UE is allowed to perform, without using the measurement gap, the inter-system measurement on the system to be measured; when the measurement capability indicates that the UE does not support performing, without using the measurement gap, the inter-system measurement on the system to be measured, the indication information determined by the network device indicating that the UE is not allowed to perform, without using the measurement gap, the inter-system measurement on the system to be measured.

At step S203, the network device sends the measurement configuration information to the UE, where the measurement configuration information includes the indication information.

After receiving the measurement configuration information, the UE is informed, based on the indication information, about whether it is allowed to perform, without using the measurement gap, the inter-system measurement on the system to be measured.

At step S204, in response to the indication information indicating that the UE is allowed to perform, without using the measurement gap, the inter-system measurement on the system to be measured, the network device performs, in the measurement gap, a transmission scheduling on the UE for service data, and when a frequency-domain range of a reference signal of a carrier to be measured in the system to be measured is within an active DLBWP of the UE, the UE performs, without using the measurement gap, the inter-system measurement on the system to be measured, and receives, in the measurement gap, the transmission scheduling for the service data performed by the network device on the UE.

In a possible embodiment, step S204 further includes: in response to the indication information indicating that the UE is not allowed to perform, without using the measurement gap, the inter-system measurement on the system to be measured, the network device does not perform, in the measurement gap, the transmission scheduling on the UE for service data, and when the frequency-domain range of the reference signal of the carrier to be measured in the system to be measured is within the active DLBWP of the UE, the UE performs, by using the measurement gap, the inter-system measurement on the system to be measured.

In some possible embodiments, the system to be measured is an NR system, the inter-system measurement is an NR carrier measurement performed by the UE in an LTE system in multi-radio MR-DC, and the indication information is inter-RATNRmeasurementwithoutgap.

In an example, when the indication information indicates that the UE is allowed to perform, without using the measurement gap, the inter-system measurement on the system to be measured, the value of inter-RATNRmeasurementwithoutgap is ture; and when the indication information indicates that the UE is not allowed to perform, without using the measurement gap, the inter-system measurement on the system to be measured, the value of inter-RATNRmeasurementwithoutgap is false.

In some possible embodiments, the system to be measured is an evolved UMTS terrestrial radio access (E-UTRA) system, the inter-system measurement is an LTE carrier measurement performed by the UE in an NR system, and the indication information is inter-RATE-UTRANmeasurementwithoutgap.

In an example, when the indication information indicates that the UE is allowed to perform, without using the measurement gap, the inter-system measurement on the system to be measured, the value of inter-RATE-UTRANmeasurementwithoutgap is ture; and when the indication information indicates that the UE is not allowed to perform, without using the measurement gap, the inter-system measurement on the system to be measured, the value of inter-RATE-UTRANmeasurementwithoutgap is false.

In the embodiments of the present disclosure, the UE reports to the network device the measurement capability about whether the UE supports performing the inter-system measurement on the system to be measured without using the measurement gap, and the network device sets corresponding indication information for the UE based on the measurement capability, enabling the UE to be informed about whether the inter-system measurement on the system to be measured is allowed to be performed without using the measurement gap, and therefore, in the case that the network device configures the measurement gap for the UE, after the UE receives the indication configured by the network device to allow the inter-system measurement on the system to be measured to be performed without using the measurement gap, when a frequency-domain range of a reference signal of a carrier to be measured in the system to be measured is within an active DLBWP of the UE, the UE can perform the inter-system measurement on the system to be measured without using the measurement gap. In this way, the need to suspend the service of the servicing cell is eliminated, and the service processing capability is improved.

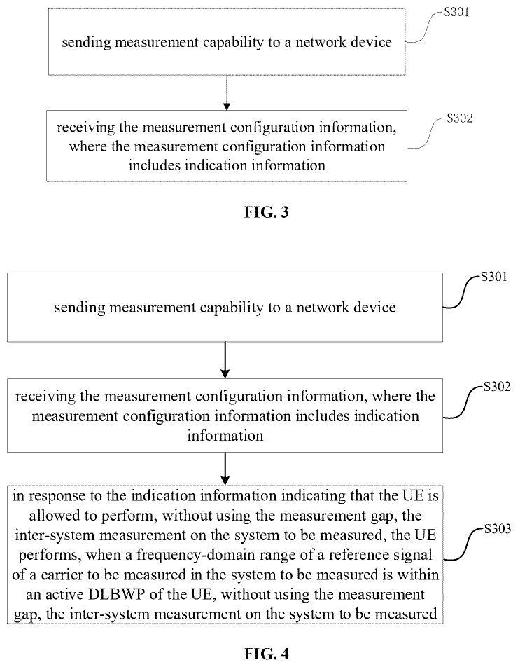

The embodiments of the present disclosure provide a method for transmitting measurement configuration information that is performed by a UE. FIG. 3 is a flowchart of a method for transmitting measurement configuration information illustrated according to an exemplary embodiment. As shown in FIG. 3, the method includes steps S301 to S302, and the specifics are as follows.

At step S301, measurement capability is sent to a network device.

The measurement capability is used for indicating whether the UE supports performing, without using a measurement gap, an inter-system measurement on a system to be measured.

In a possible embodiment, sending the measurement capability to the network device is performed by sending to the network device IEMeasAndMobParameters signaling or IEMeasAndMobParametersMRDC signaling including the measurement capability.

At step S302, the measurement configuration information is received, where the measurement configuration information includes indication information.

The indication information is used for indicating whether the UE is allowed to perform, without using the measurement gap, the inter-system measurement on the system to be measured.

In some possible embodiments, the system to be measured is an NR system, the inter-system measurement is an NR carrier measurement performed by the UE in an LTE system in multi-radio MR-DC, and the indication information is inter-RATNRmeasurementwithoutgap.

In an example, when the indication information indicates that the UE is allowed to perform, without using the measurement gap, the inter-system measurement on the system to be measured, the value of inter-RATNRmeasurementwithoutgap is ture; and when the indication information indicates that the UE is not allowed to perform, without using the measurement gap, the inter-system measurement on the system to be measured, the value of inter-RATNRmeasurementwithoutgap is false.

In some possible embodiments, the system to be measured is a E-UTRA system, the inter-system measurement is an LTE carrier measurement performed by the UE in an NR system, and the indication information is inter-RATE-UTRANmeasurementwithoutgap.

In an example, when the indication information indicates that the UE is allowed to perform, without using the measurement gap, the inter-system measurement on the system to be measured, the value of inter-RATE-UTRANmeasurementwithoutgap is ture; and when the indication information indicates that the UE is not allowed to perform, without using the measurement gap, the inter-system measurement on the system to be measured, the value of inter-RATE-UTRANmeasurementwithoutgap is false.

The embodiments of the present disclosure provide a method for transmitting measurement configuration information that is performed by a UE. FIG. 4 is a flowchart of a method for transmitting measurement configuration information illustrated according to an exemplary embodiment. As shown in FIG. 4, the method includes steps S301 to S303, and the specifics are as follows.

Steps S301 to S302 are the same as steps S301 to S302 in the previous embodiment.

At step S303, in response to the indication information indicating that the UE is allowed to perform, without using the measurement gap, the inter-system measurement on the system to be measured, the UE performs, when a frequency-domain range of a reference signal of a carrier to be measured in the system to be measured is within an active DLBWP of the UE, without using the measurement gap, the inter-system measurement on the system to be measured.

In some possible embodiments, in response to the indication information indicating that the UE is allowed to perform, without using the measurement gap, the inter-system measurement on the system to be measured, a transmission scheduling for service data performed by the network device on the UE is received in the measurement gap.

In some possible embodiments, in response to the indication information indicating that the UE is not allowed to perform, without using the measurement gap, the inter-system measurement on the system to be measured, the inter-system measurement on the system to be measured is performed by using the measurement gap.

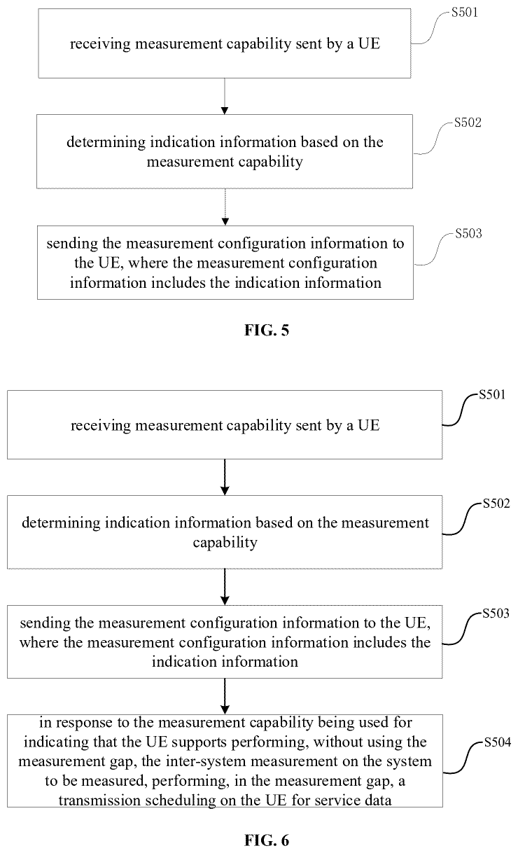

The embodiments of the present disclosure provide a method for transmitting measurement configuration information that is performed by a network device. FIG. 5 is a flowchart of a method for transmitting measurement configuration information illustrated according to an exemplary embodiment. As shown in FIG. 5, the method includes steps S501 to S503, and the specifics are as follows.

At step S501, measurement capability sent by a UE is received.

The measurement capability is used for indicating whether the UE supports performing, without using a measurement gap, an inter-system measurement on a system to be measured.

In a possible embodiment, receiving the measurement capability sent by the UE is receiving IEMeasAndMobParameters signaling or IEMeasAndMobParametersMRDC signaling including the measurement capability sent by the UE.

At step S502, indication information is determined based on the measurement capability.

The indication information is used for indicating whether the UE is allowed to perform, without using the measurement gap, the inter-system measurement on the system to be measured.

In a possible embodiment, in response to the measurement capability being used for indicating that the UE supports performing, without using the measurement gap, the inter-system measurement on the system to be measured, the indication information is determined to be used for indicating that the UE is allowed to perform, without using the measurement gap, the inter-system measurement on the system to be measured.

In response to the measurement capability being used for indicating that the UE does not support performing, without using the measurement gap, the inter-system measurement on the system to be measured, the indication information is determined to be used for indicating that the UE is not allowed to perform, without using the measurement gap, the inter-system measurement on the system to be measured.

At step S503, the measurement configuration information is sent to the UE, where the measurement configuration information includes the indication information.

In a possible embodiment, the system to be measured is an NR system, the inter-system measurement is an NR carrier measurement performed by the UE in an LTE system in multi-radio MR-DC; the indication information indicating that the UE is allowed to perform, without using the measurement gap, the inter-system measurement on the system to be measured is inter-RATNRmeasurementwithoutgap set to true; and the indication information indicating that the UE is not allowed to perform, without using the measurement gap, the inter-system measurement on the system to be measured is inter-RATNRmeasurementwithoutgap set to false.

In a possible embodiment, the system to be measured is a E-UTRA system, the inter-system measurement is an LTE carrier measurement performed by the UE in an NR system; the indication information indicating that the UE is allowed to perform, without using the measurement gap, the inter-system measurement on the system to be measured is inter-RATE-UTRANmeasurementwithoutgap set to true; and the indication information indicating that the UE is not allowed to perform, without using the measurement gap, the inter-system measurement on the system to be measured is inter-RATE-UTRANmeasurementwithoutgap set to false.

The embodiments of the present disclosure provide a method for transmitting measurement configuration information that is performed by a network device. FIG. 6 is a flowchart of a method for transmitting measurement configuration information illustrated according to an exemplary embodiment. As shown in FIG. 6, the method includes steps S501 to S504, and the specifics are as follows.

Steps S501 to S503 are the same as steps S501 to S503 in the previous embodiment.

At step S504, in response to the measurement capability being used for indicating that the UE supports performing, without using the measurement gap, the inter-system measurement on the system to be measured, a transmission scheduling for service data is performed on the UE in the measurement gap.

In some possible embodiments, the method further includes, in response to the measurement capability being used for indicating that the UE supports performing, without using the measurement gap, the inter-system measurement on the system to be measured, a transmission scheduling is not performed, in the measurement gap, on the UE for service data.

Based on the same idea as the above method embodiments, the embodiments of the present disclosure also provide a communication device. The communication device may have the function of the UE 102 in the above method embodiments and be configured to perform the steps provided in the above embodiments executed by the UE 102. The function may be implemented by hardware, or may be implemented by software or hardware executing corresponding software. The hardware or software includes one or more modules corresponding to the above-described function.

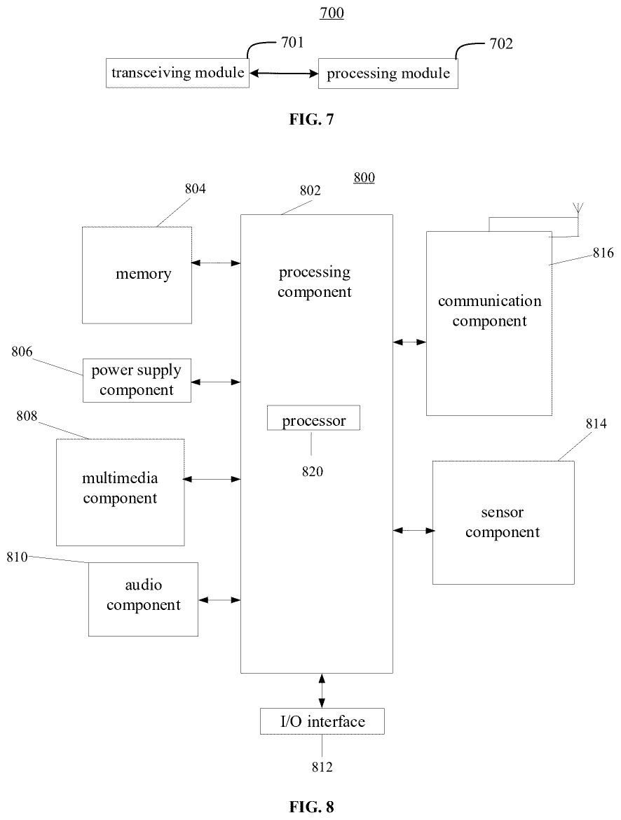

In a possible implementation, the communication device 700 as shown in FIG. 7 may serve as the UE 102 involved in the above method embodiments, and perform the steps executed by the UE 102 in one of the above method embodiments.

The communication device 700 includes a transceiving module 701 and a processing module 702.

The transceiving module 701 is configured to send measurement capability to a network device, where the measurement capability is used for indicating whether the UE supports performing, without using a measurement gap, an inter-system measurement on a system to be measured; and the transceiving module is further configured to receive measurement configuration information, where the measurement configuration information includes indication information, and the indication information is used for indicating whether the UE is allowed to perform, without using the measurement gap, the inter-system measurement on the system to be measured.

In some possible embodiments, the processing module 702 is configured to: in response to the indication information indicating that the UE is allowed to perform, without using the measurement gap, the inter-system measurement on the system to be measured, perform, when a frequency-domain range of a reference signal of a carrier to be measured in the system to be measured is within an active DLBWP of the UE, the inter-system measurement on the system to be measured without using the measurement gap.

In some possible embodiments, the processing module 702 is further configured to receive, in the measurement gap, a transmission scheduling for service data performed by the network device on the UE.

In some possible embodiments, the processing module 702 is further configured to: in response to the indication information indicating that the UE is not allowed to perform, without using the measurement gap, the inter-system measurement on the system to be measured, perform, by using the measurement gap, the inter-system measurement on the system to be measured.

In some possible embodiments, the transceiving module 701 is further configured to send, to the network device, IEMeasAndMobParameters signaling or IEMeasAndMobParametersMRDC signaling including the measurement capability.

In some possible embodiments, the system to be measured is an NR system, the inter-system measurement is an NR carrier measurement performed by the UE in an LTE system in multi-radio MR-DC, and the indication information is inter-RATNRmeasurementwithoutgap; or the system to be measured is a E-UTRA system, the inter-system measurement is an LTE carrier measurement performed by the UE in an NR system, and the indication information is inter-RATE-UTRANmeasurementwithoutgap.

When the communication device is the UE 102, its structure may also be shown in FIG. 8.

FIG. 8 is a block diagram of a device 800 for transmitting measurement configuration information illustrated according to an exemplary embodiment. For example, the device 800 may be a cell phone, a computer, a digital broadcast terminal, a message transceiver device, a game console, a tablet device, a medical device, a fitness device, or a personal digital assistant.

Referring to FIG. 8, the device 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls overall operation of the device 800, such as operations associated with display, telephone calls, data communication, camera operations, and recording operations. The processing component 802 may include one or more processors 820 to execute an instruction, thereby completing all or some of the steps of the methods described above. In addition, the processing component 802 may include one or more modules that facilitate interaction between the processing component 802 and other components. For example, the processing component 802 may include a multimedia module to facilitate interaction between the multimedia component 808 and the processing component 802.

The memory 804 is configured to store various types of data to support operations at the device 800. Examples of such data include the following for any application program or method operated on the device 800: instructions, contact data, phonebook data, messages, pictures, videos, etc. The memory 804 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk, or a CD-ROM.

The power supply component 806 supplies power to various components of the device 800. The power supply component 806 may include a power supply management system, one or more power supplies, and other components associated with generating, managing and distributing power for the device 800.

The multimedia component 808 includes a screen that provides an output interface between the device 800 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensor may not only sense the boundaries of the touch or swipe action, but also detect the duration and pressure associated with the touch or swipe operation. In some embodiments, the multimedia component 808 includes a front-facing camera and/or a rear-facing camera. The front-facing camera and/or the rear-facing camera may receive external multimedia data when the device 800 is in an operating mode, such as a shooting mode or a video mode. Each of the front-facing camera and the rear-facing camera may be a fixed optical lens system or have a focal length and optical zoom capability.

The audio component 810 is configured to output and/or input audio signals. For example, the audio component 810 includes a microphone (MIC), configured to receive external audio signals when the device 800 is in an operating mode, such as a calling mode, a recording mode and a voice recognition mode. The received audio signals may be further stored in the memory 804 or sent via the communication component 816. In some embodiments, the audio component 810 further includes a speaker for outputting the audio signals.

The I/O interface 812 provides an interface between the processing component 802 and a peripheral interface module, and the peripheral interface module described above may be a keypad, a click wheel, a button, etc. These buttons may include, but are not limited to, a home button, a volume button, a start button, and a lock button.

The sensor component 814 includes one or more sensors configured to provide status assessment of various aspects of the device 800. For example, the sensor component 814 may detect an open/closed state of the device 800, relative positioning of the components, for example, the components are the display and small keypad of the device 800; the sensor component 814 may also detect a change in the position of the device 800 or a change in the position of one component of the device 800, the presence or absence of user contact with the device 800, the orientation or acceleration/deceleration of the device 800, and temperature changes of the device 800. The sensor component 814 may include a proximity sensor that is configured to detect the presence of nearby objects in the absence of any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate the communication between the device 800 and other devices by wired or wireless means. The device 800 may access a wireless network based on a communication standard, such as WiFi, 4G, 5G, or a combination thereof. In an exemplary embodiment, the communication component 816 receives broadcast signals or broadcast-related information from an external broadcast management system via a broadcast channel. In an exemplary embodiment, the communication component 816 further includes a near-field communication (NFC) module to facilitate short-range communication. For example, the NFC module may be implemented based on the radio frequency identification (RFID) technology, the infrared data association (IrDA) technology, the ultra-wideband (UWB) technology, the Bluetooth (BT) technology, and the like.

In an exemplary embodiment, the device 800 may be implemented by one or more of: an application-specific integrated circuit (ASIC), a digital signal processor (DSP), a digital signal processing device (DSPD), a programmable logic device (PLD), a field-programmable gate array (FPGA), a controller, a microcontroller, a microprocessor, or other electronic elements, to perform the above methods.

In an exemplary embodiment, a non-transitory computer-readable storage medium including an instruction is also provided, such as the memory 804 including an instruction. The instruction described above is capable of being executed by the processor 820 of the device 800 to complete the above methods. For example, the non-transitory computer-readable storage medium may be an ROM, a random access memory (RAM), a CD-ROM, a magnetic tape, a floppy disk, or an optical data storage device.

Based on the same idea as the above method embodiments, the embodiments of the present disclosure also provide a communication device. The communication device may have the function of the network device 101 in the above method embodiments and be configured to perform the steps provided in the above embodiments executed by the network device 101. The function may be implemented by hardware, or may be implemented by software or hardware executing corresponding software. The hardware or software includes one or more modules corresponding to the above-described function.

In a possible implementation, the communication device 900 as shown in FIG. 9 may serve as the network device 101 involved in the above method embodiments, and perform the steps executed by the network device 101 in the above method embodiments.

The communication device 900 as shown in FIG. 9 includes a transceiving module 901 and a processing module 902.

The transceiving module 901 is configured to receive measurement capability sent by a UE, where the measurement capability is used for indicating whether the UE supports performing, without using a measurement gap, an inter-system measurement on a system to be measured.

The processing module 902 is configured to determine indication information based on the measurement capability, where the indication information is used for indicating whether the UE is allowed to perform, without using the measurement gap, the inter-system measurement on the system to be measured.

The transceiving module 901 is further configured to send measurement configuration information to the UE, where the measurement configuration information includes the indication information.

In some possible embodiments, the transceiving module 901 is further configured to receive IEMeasAndMobParameters signaling or IEMeasAndMobParametersMRDC signaling including the measurement capability sent by the UE.

In some possible embodiments, the processing module 902 is further configured to: in response to the measurement capability being used for indicating that the UE supports performing, without using the measurement gap, the inter-system measurement on the system to be measured, determine the indication information is used for indicating that the UE is allowed to perform, without using the measurement gap, the inter-system measurement on the system to be measured.

In some possible embodiments, the transceiving module 901 is further configured to perform, in the measurement gap, a transmission scheduling on the UE for service data.

In some possible embodiments, the processing module 902 is further configured to: in response to the measurement capability being used for indicating that the UE does not support performing, without using the measurement gap, the inter-system measurement on the system to be measured, determine the indication information is used for indicating that the UE is not allowed to perform, without using the measurement gap, the inter-system measurement on the system to be measured.

In some possible embodiments, the system to be measured is an NR system, the inter-system measurement is an NR carrier measurement performed by the UE in an LTE system in multi-radio MR-DC, the indication information indicating that the UE is allowed to perform, without using the measurement gap, the inter-system measurement on the system to be measured is inter-RATNRmeasurementwithoutgap set to true; or
the system to be measured is a E-UTRA system, the inter-system measurement is an LTE carrier measurement performed by the UE in an NR system, and the indication information indicating that the UE is allowed to perform, without using the measurement gap, the inter-system measurement on the system to be measured is inter-RATE-UTRANmeasurementwithoutgap set to true.

In some possible embodiments, the system to be measured is an NR system, the inter-system measurement is an NR carrier measurement performed by the UE in an LTE system in multi-radio MR-DC, the indication information indicating that the UE is not allowed to perform, without using the measurement gap, the inter-system measurement on the system to be measured is inter-RATNRmeasurementwithoutgap set to false; or
the system to be measured is a E-UTRA system, the inter-system measurement is an LTE carrier measurement performed by the UE in an NR system, and the indication information indicating that the UE is not allowed to perform, without using the measurement gap, the inter-system measurement on the system to be measured is inter-RATE-UTRANmeasurementwithoutgap set to false.

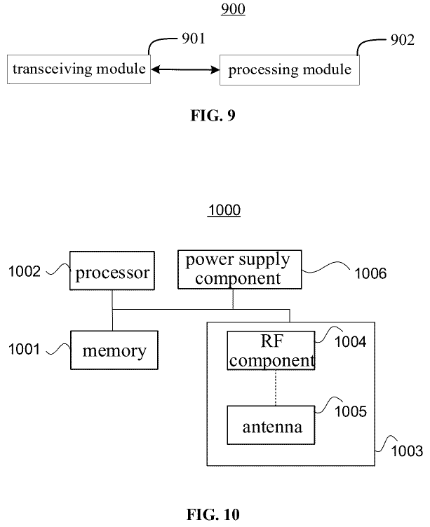

When the communication device is a network device 101, its structure may also be shown in FIG. 10. As shown in FIG. 10, the device 1000 includes a memory 1001, a processor 1002, a transceiver component 1003, and a power supply component 1006. The memory 1001 is coupled to the processor 1002, and may be configured to save programs and data necessary for the communication device 1000 to implement various functions. The processor 1002 is configured to support the communication device 1000 in performing the corresponding function in the above methods, and the function may be implemented by invoking a program stored in the memory 1001. The transceiver component 1003 may be a wireless transceiver that may be configured to support the communication device 1000 in performing, via a wireless air interface, receiving signaling and/or data, and sending signaling and/or data. The transceiver component 1003 may also be referred to as a transceiver unit or a communication unit, and the transceiver component 1003 may include an RF component 1004 and one or more antennas 1005, where the RF component 1004 may be a remote radio unit (RRU), which may be specifically configured for transmission of RF signals and conversion between RF signals and baseband signals, and the one or more antennas 1005 may be specifically configured to perform radiation and reception of RF signals.

When the communication device 1000 needs to send data, the processor 1002, after performing baseband processing on the data to be sent, may output a baseband signal to an RF unit, and the RF unit, after performing RF processing on the baseband signal, sends the RF signal in the form of electromagnetic waves through the antenna. When there is data sent to the communication device 1000, the RF unit receives an RF signal through the antenna, converts the RF signal to a baseband signal, and outputs the baseband signal to the processor 1002, and the processor 1002 converts the baseband signal to data and processes the data.

After considering the specification and practicing the invention disclosed herein, those skilled in the art will easily come up with other implementation solutions of the embodiments of the present disclosure. The present application is intended to cover any variations, uses or adaptive changes of the embodiments of the present disclosure, and the variations, uses or adaptive changes follow the general principles of the embodiments of the present disclosure and include common knowledge or commonly used technical means in the art that are not disclosed in the present disclosure. The specification and embodiments are only considered to be exemplary, and the true scope and spirit of the embodiments of the present disclosure are indicated by the following claims.

It should be understood that the embodiments of the present disclosure are not limited to the precise structure which has been described above and illustrated in the accompanying drawings, and that various modifications and alterations may be made without departing from the scope of the embodiments of the present disclosure. The scope of the embodiments of the present disclosure is limited only by the appended claims.

### INDUSTRIAL APPLICABILITY

The UE reports to the network device the measurement capability about whether the UE supports performing the inter-system measurement on the system to be measured without using the measurement gap, and the network device sets corresponding indication information for the UE based on the measurement capability, enabling the UE to be informed about whether the inter-system measurement on the system to be measured is allowed to be performed without using the measurement gap, and therefore, in the case that the network device configures the measurement gap for the UE, after the UE receives the indication configured by the network device to allow the inter-system measurement on the system to be measured to be performed without using the measurement gap, when a frequency-domain range of a reference signal of a carrier to be measured in the system to be measured is within an active DLBWP of the UE, the UE can perform the inter-system measurement on the system to be measured without using the measurement gap. In this way, the need to suspend the service of the servicing cell is eliminated, and the service processing capability is improved.

1. A method for transmitting measurement configuration information, performed by a user equipment (UE), wherein the method comprises:
sending measurement capability to a network device, wherein the measurement capability is used for indicating whether the UE supports performing, without using a measurement gap, an inter-system measurement on a system to be measured; and
receiving the measurement configuration information, wherein the measurement configuration information comprises indication information, and the indication information is used for indicating whether the UE is allowed to perform the inter-system measurement on the system without using the measurement gap.

2. The method according to claim 1, further comprising:
in response to the indication information indicating that the UE is allowed to perform the inter-system measurement on the system without using the measurement gap, performing, when a frequency-domain range of a reference signal of a carrier to be measured in the system is within an active downlink bandwidth part (DLBWP) of the UE, the inter-system measurement on the system without using the measurement gap.

3. The method according to claim 2, further comprising:
receiving, in the measurement gap, a transmission scheduling for service data from the network device.

4. The method according to claim 1, further comprising:
in response to the indication information indicating that the UE is not allowed to perform the inter-system measurement on the system without using the measurement gap, performing, by using the measurement gap, the inter-system measurement on the system.

5. The method according to claim 1, wherein the sending the measurement capability to the network device comprises:
sending, to the network device, IEMeasAndMobParameters signaling or IEMeasAndMobParametersMRDC signaling including the measurement capability.

6. The method according to claim 1, wherein
the system to be measured is a new radio (NR) system, the inter-system measurement is an NR carrier measurement performed by the UE in long term evolution (LTE) system in multi-radio dual connectivity (MR-DC), and the indication information is inter-RATNRmeasurementwithoutgap; or
the system to be measured is an evolved universal mobile telecommunications system (UMTS) terrestrial radio access (E-UTRA) system, the inter-system measurement is an LTE carrier measurement performed by the UE in an NR system, and the indication information is inter-RATE-UTRANmeasurementwithoutgap.

7. A method for transmitting measurement configuration information, performed by a network device, wherein the method comprises:
receiving measurement capability sent by a user equipment (UE), wherein the measurement capability is used for indicating whether the UE supports performing, without using a measurement gap, an inter-system measurement on a system to be measured;
determining indication information based on the measurement capability, wherein the indication information is used for indicating whether the UE is allowed to perform the inter-system measurement on the system without using the measurement gap; and
sending the measurement configuration information to the UE, wherein the measurement configuration information comprises the indication information.

8. The method according to claim 7, wherein the receiving the measurement capability sent by the UE comprises:
receiving IEMeasAndMobParameters signaling or IEMeasAndMobParametersMRDC signaling including the measurement capability sent by the UE.

9. The method according to claim 67, wherein the determining the indication information based on the measurement capability comprises:
in response to the measurement capability being used for indicating that the UE supports performing the inter-system measurement on the system without using the measurement gap, determining the indication information is used for indicating that the UE is allowed to perform the inter-system measurement on the system without using the measurement gap.

10. The method according to claim 9, further comprising:
performing, in the measurement gap, a transmission scheduling on the UE for service data.

11. The method according to claim 7, wherein the determining the indication information based on the measurement capability comprises:
in response to the measurement capability being used for indicating that the UE does not support performing the inter-system measurement on the system without using the measurement gap, determining the indication information is used for indicating that the UE is not allowed to perform the inter-system measurement on the system without using the measurement gap.

12. The method according to claim 7, wherein
the system to be measured is a new radio (NR) system, the inter-system measurement is an NR carrier measurement performed by the UE in long term evolution (LTE) system in multi-radio dual connectivity (MR-DC), the indication information indicating that the UE is allowed to perform, without using the measurement gap, the inter-system measurement on the system to be measured is inter-RATNRmeasurementwithoutgap set to true; or
the system to be measured is an evolved universal mobile telecommunications system (UMTS) terrestrial radio access (E-UTRA) system, the inter-system measurement is an LTE carrier measurement performed by the UE in an NR system, and the indication information indicating that the UE is allowed to perform, without using the measurement gap, the inter-system measurement on the system to be measured is inter-RATE-UTRANmeasurementwithoutgap set to true.

13. The method according to claim 7, wherein
the system to be measured is an NR system, the inter-system measurement is an NR carrier measurement performed by the UE in an LTE system in MR-DC, the indication information indicating that the UE is not allowed to perform, without using the measurement gap, the inter-system measurement on the system to be measured is inter-RATNRmeasurementwithoutgap set to false; or
the system to be measured is a E-UTRA system, the inter-system measurement is an LTE carrier measurement performed by the UE in an NR system, and the indication information indicating that the UE is not allowed to perform, without using the measurement gap, the inter-system measurement on the system to be measured is inter-RATE-UTRANmeasurementwithoutgap set to false.

14.-26. (canceled)

27. A communication device, comprising:
a processor; and
a memory, wherein
the memory is configured to store a computer program; and
the processor, through executing the computer program, is configured to:
send measurement capability to a network device, wherein the measurement capability is used for indicating whether the UE supports performing, without using a measurement gap, an inter-system measurement on a system to be measured; and
receive measurement configuration information, wherein the measurement configuration information comprises indication information, and the indication information is used for indicating whether the UE is allowed to perform the inter-system measurement on the system without using the measurement gap.

28. A communication device, comprising a processor and a memory, wherein
the memory is configured to store a computer program; and
the processor is configured to execute the computer program, thereby implementing the method according to claim 7.

29. A non-transitory computer-readable storage medium, wherein the computer-readable storage medium stores an instruction that, when invoked and executed on a computer, causes the computer to perform the method according to claim 1.

30. A non-transitory computer-readable storage medium, wherein the computer-readable storage medium stores an instruction that, when invoked and executed on a computer, causes the computer to perform the method according to claim 7.

31. The communication device according to claim 27, wherein the processor is further configured to:
in response to the indication information indicating that the UE is allowed to perform the inter-system measurement on the system without using the measurement gap, perform, when a frequency-domain range of a reference signal of a carrier to be measured in the system is within an active downlink bandwidth part (DLBWP) of the UE, the inter-system measurement on the system without using the measurement gap.

32. The communication device according to claim 31, wherein the processor is further configured to:
receive, in the measurement gap, a transmission scheduling for service data from the network device.

33. The communication device according to claim 27, wherein the processor is further configured to:
in response to the indication information indicating that the UE is not allowed to perform the inter-system measurement on the system without using the measurement gap, perform, by using the measurement gap, the inter-system measurement on the system.
